(19) United States
(12) Patent Application Publication
(10) Pub. No.: US 2016/0109714 A1
(43) Pub. Date: Apr. 21, 2016

(54) Head-Up Display Device

(71) Applicant: National Tsing Hua University, Hsinchu (TW)

(72) Inventor: Cheng-Huan Chen, Hsinchu (TW)

(21) Appl. No.: 14/970,449

(22) Filed: Dec. 15, 2015

Related U.S. Application Data
(63) Continuation-in-part of application No. 13/871,090, filed on Apr. 26, 2013.

(30) Foreign Application Priority Data
Aug. 14, 2012 (TW) 101129284

(51) Int. Cl. G02B 27/01; B60K 35/00; G03B 21/28; G02B 27/28; G02B 26/08

(52) U.S. Cl. CPC G02B 27/0179; G02B 27/283; G02B 27/0101; G02B 27/0149; G02B 26/0816; G03B 21/28; B60K 35/00; G02B 2027/0145; G02B 2027/0159; G02B 2027/0183; G02B 2027/0185; B60K 2350/2052; B60K 2350/2056; B60K 2350/2095

(57) ABSTRACT

A head-up display device operated in a vehicle comprises: a first image source and a second image source, a beam-splitter located in between. In an embodiment, two virtual images located at different positions simultaneously while both of the first and the second image sources have linear polarization but mutual orthogonal or both have an opposite-hand circular polarization associated with a corresponding polarization type beam splitter. In the second embodiment, the polarizing beam splitter is replaced by a transparent/mirror element so that one virtual image could be seen by the driver depending on the mode been selected. In the third embodiment, the beam-splitter is replaced by a mechanical movable shielding element. While the mechanical movable shielding element is disposed in the optical plane to block out the first image light, the second virtual image is chosen. While the mechanical movable shielding element is disposed off the optical plane, nothing blocks out the first image light and the second image light, no second image light is reflected by the windshield. As a result, the first virtual image is chosen to be seen by the driver.

### CROSS REFERENCE TO RELATED APPLICATIONS

This application is a continuation in part application of U.S. patent application Ser. No. 13/871,090, entitled “HEAD-UP DISPLAY DEVICE” filed on Apr. 26, 2013, which claims priority of R.O.C. Taiwan patent application Ser. No. 101129284, filed on Aug. 14, 2012, both of which are incorporated by reference in their entireties.

### FIELD OF THE INVENTION

The present invention generally relates to a head-up display device, more particularly to a head-up display device that is capable of displaying a long-distance image and a short-distance image simultaneously or one of the long-distance image and short-distance image on the eyes of a driver through polarized technologies, a switchable mirror or a general shielding/non-shielding device.

### DESCRIPTION OF THE PRIOR ART

Head-up display is the kind of display device showing images in front of the windshield of a vehicle so that the driver can see the image while keeping his or her line of sight in driving. This feature makes head-up display a suitable candidate for vehicle displays with the consideration of safety issues, especially nowadays there have been more and more demand on displaying images in driving condition, such as GPS etc. There is a human factor issue in using head-up displays, which is the accommodation of human eye between head-up display image and outside scene. The accommodation time could be critical in some specific occasions, especially in high speed driving. Ideally, head-up displays should be able to meet the requirement of different scenarios in driving. For example, the vehicle is driving in high speed on the highway, a virtual image at far distance is preferred for the driver. However, when driving at low speed to search for the correct route, the desired image distance might not be that far. Most current head-up displays show images at a specific distance from the driver and cannot adapt to diversified driving scenarios. Some of them have the function of changing image distance but require mechanical movement between image forming optical elements, whose precision can be difficult to achieve in vehicles where high speed motion and various vibration modes are involved.

With reference to FIG. 6, it illustrates a representative view of a head-up display device of a patent, issue No. M332601, of Republic of China. As shown in figure, the head-up display device is applied in a vehicle that has at least one signal generating device 2A for providing at least one signal source. The head-up display device 1A has: an HMI (Human Machine Interface) 19A, which electrically connects with the signal generating device 2A for selecting the signal source; an interface circuit 11A, which receives the signal source selected by the HMI 19A and transforms the signal source to an image signal; an imaging surface 17A, which essentially forms on the windshield of the vehicle; and a projecting unit 15A, which receives the imaging signal from the interface circuit 11A and transforms the imaging signals to a screen that is projected to the imaging surface 17A, wherein the projecting unit 15A further has a lens, a DMD (Digital Micromirror Device) and a camera lens (not shown in figure), the image signal is projected to the DMD through the lens, so that the screen is formed on the DMD, and thus the screen is projected to the imaging surface 17A through the camera lens. Since the DMD receives digital signals and projects the screen via the way of digital pulse, hence its resolution is higher and facilitates to projected screens with small dimensions. As it can be seen, the applications and features of the prior art are different than the present invention's.

With reference to FIG. 7, it illustrates a representative view of a head-up display apparatus of a patent, U.S. Pat. No. 7,936,518 B2, of USA. The head-up display apparatus includes an infrared ray emitting unit 5B for emitting an infrared ray toward a user D, a mirror member 3B for reflecting visible light L emitted from a display 2B toward a combiner member 4B, and transmitting the infrared ray reflected by the user D and the combiner member 4B, a plurality of imaging units 6B and 7B disposed to face the mirror member 3B for sensing the infrared ray, each imaging the user from differing directions, and an image processing unit 8B for calculating the eye position of the user based on an image captured by the imaging units 6B and 7B. Hence, talking about functions, the patent of U.S. Pat. No. 8,035,879 B2 adopts that the infrared ray and visible light are projected to the windshield and further reflected to the eye of the user, thus the image processing unit is able to capture the status and position of the eye. As a conclusion, the prior art is to capture the position of the eye so as to avoid the driver dozes while in driving. So the applications and features of the prior art are different than the present invention's.

With a reference to FIG. 8, it illustrates a representative view of a head-up display apparatus of a patent, U.S. Pat. No. 5,140,465 B2, of USA. The head-up display apparatus includes a single indicator 81, a first concave mirror 82, a plane mirror 83 and a second concave mirror 84. The first concave mirror 82 can be moved in and out of the image forming light path. When the first concave mirror 82 is in the light path, the display image is magnified by the first concave mirror 82 and second concave mirror 84, and is located at remote position from the driver. When the first concave mirror is moved out of the light path, the light from the indicator is simply reflected by the plane mirror 83, and the virtual display image is located at a position closer to the driver. Although the prior art is capable of showing head-up display image at different positions from the driver, it uses single indicator and the change of image position has to get involve with mechanical movement of optical element. So the applications and features of the prior art are different than the present invention's.

### SUMMARY OF THE INVENTION

The main objective of the present invention is to provide a head-up display device, which is able to display a long-distance mode and a short-distance mode simultaneously for specific display or warning purposes.

The other objective of the present invention is to provide the head-up display device, which can choose one of the long-distance mode or the short-distance mode based on demands. While to monitor both the images of the long-distance mode and the short-distance mode is not a must, the function of only one mode being activated is ready for the present invention.

A head-up display device operated in a vehicle is disclosed. In a first preferred embodiment, the head-up display device comprises: a first image source, a second image source and a beam-splitter. The first image source is installed in the dashboard and the second image source is mounted or hung at the ceiling but abutting the top of the windshield.

The beam-splitter may be a linear polarization type beam-splitter to allow primarily a first polarizing light having a first linear polarization component to pass but reflect primarily a second polarizing light having a second linear polarization component. The second linear polarization component is orthogonal to the first linear polarization.

The beam-splitter may be a circular polarization type to allow primarily a first polarizing light having a first circular polarization component to pass but reflect primarily a second polarizing light having a second circular polarization component. The second circular polarization component is opposite to the first circular polarization. For example the second circular polarization component is a left-hand circular polarization and the first circular polarization component is a left-hand circular polarization.

The beam-splitter is nearer the first image source than the second image source. Furthermore the position and angle thereof versus the second image source, the beam-splitter is well turned so that the reflected second polarizing light goes to the windshield can be partially but main portion reflected to the driver seat. Aside from that position of the first image source is well turned so that the main portion of the first image light reflected by the windshield can reach the field of viewing of the driver after the first polarizing image hits the windshield. As a result, two virtual images but at different positions can be seen simultaneously by the driver. A first virtual image due to the first polarizing light is a near virtual image with respect to a second virtual image due to the second polarizing light.

In a second preferred embodiment, there is a transparent/mirror switchable element disposed in the path of the first image light and the second image light and is nearer the first image source than the second image source. When the transparent/mirror switchable element is switched to a transparent mode, the transparent/mirror switchable element allows the first image light passing through and goes to the windshield and reflected by the latter. The same as the first preferred embodiment, the position and an angle of the first image source against the windshield are well tuned so that the main reflected portion of first image light is fallen in the field of viewing of the driver after the first image hits the windshield. On the other hand no second image light can be reflected by the windshield since the second image light goes in a direction away from the windshield after passing the transparent/mirror switchable element.

When the transparent/mirror switchable element is switched to a mirror mode, the transparent/mirror switchable element blocks the first image light out but reflects the second image light to the windshield. Once the second image light hits the windshield and is reflected by the latter, the main portion of reflected second image light goes to the driver seat since the position and the angle of the transparent/mirror switchable element versus the position of the second image source is well tuned so that the main reflected portion of second image light will be fallen in the field of viewing of the driver.

The same as the first preferred embodiment the transparent/mirror switchable element is nearer the first image source than the second image source so that the first virtual image due to the first image light is a near virtual image versus a second virtual image, which is a remote virtual image.

In the second preferred the driver cannot see the first virtual image and the second virtual image simultaneously.

In a third preferred embodiment, a mechanical movable shielding element is substituted for the transparent/mirror switchable element and the mechanical movable shielding element has a curvature mirror surface facing the second image source.

While the mechanical movable shielding element is driven into the optical axis plane to block out the first image light, no first image light can be reflected by the windshield. By contrast, the second image light is reflected by the mechanical movable shielding element. The position and the angle of the mechanical movable shielding element with respect to the second image source is well tuned so that the main reflected portion of second image light is fallen in the field of viewing of the driver after the reflected second image hits the windshield.

While the mechanical movable shielding element is driven off the optical axis plane either by shifting or by turning around an axis. In the situation, nothing in front of the first image source but the windshield only. As a result, the first image light directly goes to the windshield and then further is reflected by the latter. The main reflected first image light will then arrive the field of the viewing of the driver. A first virtual image is thus can be seen by the driver.

On the other hand, the mechanical movable shielding element is no longer in front of the second optical axis. No second image light can be reflected by the windshield.

In the third preferred the driver cannot see the first virtual image and the second virtual image simultaneously but a single virtual image only.

In a modified third preferred embodiment the second image source is moveable along the second optical axis. In a preferred embodiment the quantity of the displacement is dependent on the vehicle speed.

### BRIEF DESCRIPTION OF THE DRAWINGS

The objects, spirits, and advantages of the preferred embodiments of the present invention will be readily understood by the accompanying drawings and detailed descriptions, wherein:

FIG. 1 illustrates a schematic view of a first preferred embodiment of the head-up display device of the present invention;

FIG. 1A illustrates a schematic view of a modified embodiment of the first preferred embodiment of the head-up display device of the present invention;

FIG. 2 illustrates a schematic view of a first part of a second preferred embodiment of the head-up display device of the present invention;

FIG. 3 illustrates a schematic view of a second part of the second preferred embodiment of the present invention;

FIG. 3A illustrates a schematic view of a modified embodiment of the second preferred embodiment of the head-up display device of the present invention;

FIG. 4 illustrates a schematic view of a third preferred embodiment having a mechanical movable shielding element disposed in the optical plane so as to choose the second virtual image.

FIG. 4a illustrates a schematic view of a third preferred embodiment having a mechanical movable shielding element disposed in the optical plane so as to choose the second virtual image, and the second image source is movable along the second optical axis.

FIG. 5 illustrates a schematic view of a third preferred embodiment having a mechanical movable shielding element disposed off the optical plane so as to choose the first virtual image.

FIG. 5A shows the mechanical movable shielding element is turned around a pivot by a predetermined angle so that nothing present in the path of the first image light and the second image light.

FIG. 6 illustrates a representative view of a head-up display device in accordance with the prior art.

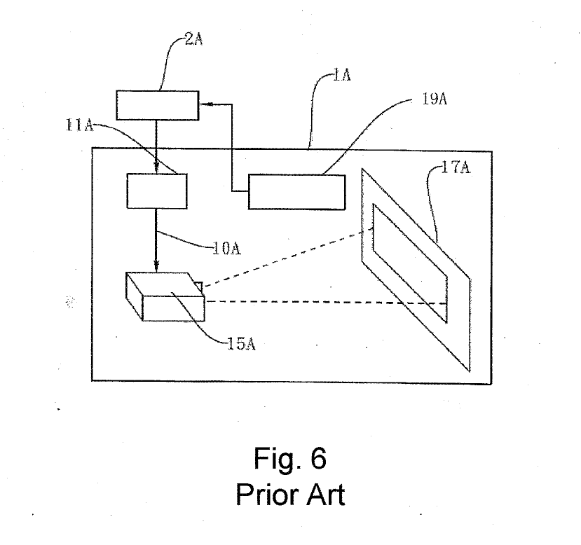

FIG. 7 illustrates a representative view of a head-up display device in accordance with the prior art.

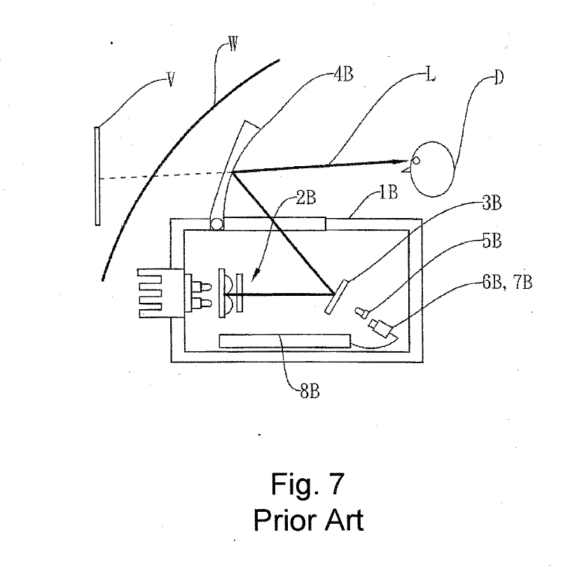

FIG. 8 illustrates a representative view of a head-up display apparatus device in accordance with the prior art.

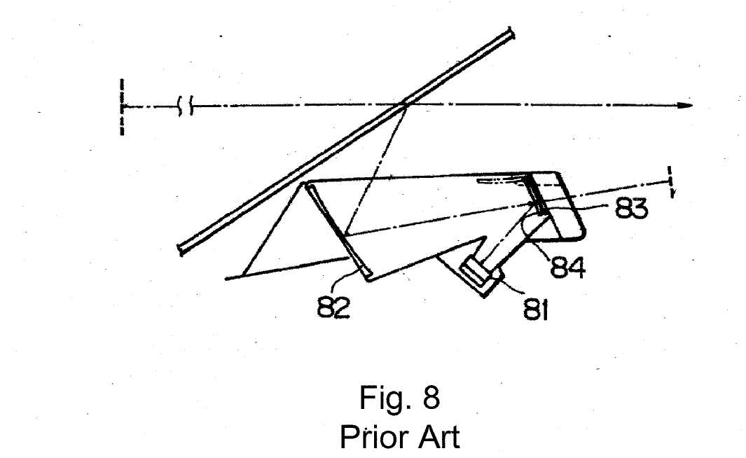

### DETAILED DESCRIPTION OF THE INVENTION

Following preferred embodiments and figures will be described in detail so as to achieve aforesaid objects.

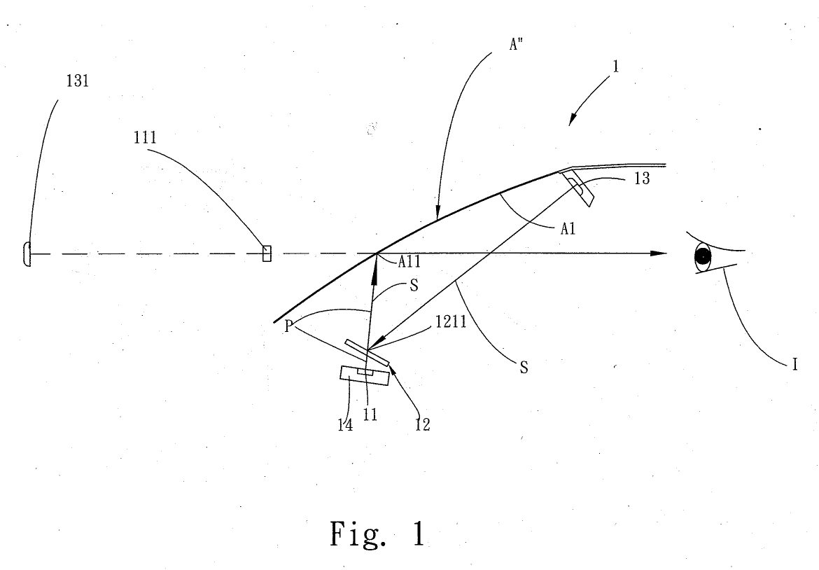

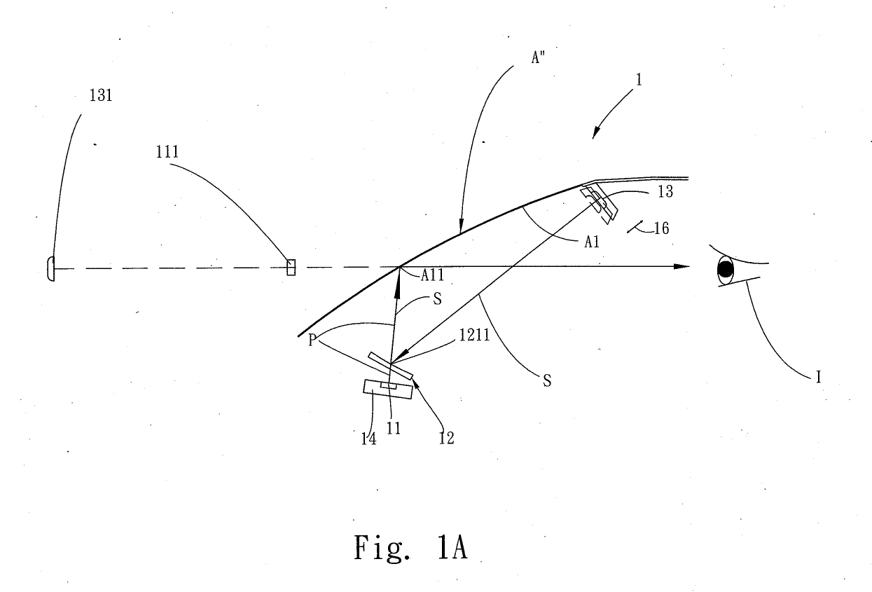

With reference to FIG. 1, it illustrates a schematic view of a first preferred embodiment of the head-up display device of the present invention. As shown in figure, the head-up display device 1 that is operated in a vehicle includes: a first image source 11, which is disposed under the windshield A″ and installed in the dashboard 14 of the vehicle and a second image source 13, which is mounted or hung at the ceiling of the vehicle abutting the windshield A″. In front of the first image source 11 is a light path combining component 12. The first image source 11 emits a first polarized image light P having a first polarization p. The polarization of the first polarization p of the first polarized image light P may be a right-hand circular polarization or a P-state linear polarization. The second image source 13 emits a second polarized image light S having a second polarization s, the polarization of the second polarization s of the second polarized image light S may be a left-hand circular polarization or a S-state linear polarization. The light path combining component 12 is a circular polarizing type beam splitter 12 while the polarized light P is a right-hand circular polarization and the polarized light S is a left-hand circular polarization. The circular polarizing type beam splitter 12 allows the polarized light P to pass through but reflects the polarized light S and vice versa. On the other hand, the light path combining component 12 is a linear polarizing type beam splitter corresponding to the polarized light P and S, which are mutual orthogonal linear polarization. The light path combining component 12 allows light with the P-state linear polarization to pass through but reflects light with the S-state linear polarization.

To illustrate conveniently in the herein and thereafter figures, the first polarized image light P is shown only by a single line with a numeral reference P. Similarly, the single line with a numeral reference S shown in the figure is to represent the second polarized image light S. Moreover, the position and angle thereof versus the second image source 13, the beam-splitter 12 is well turned so that the reflected second polarizing light goes to the windshield A″ can be partially but main portion reflected to the driver seat I. Aside from that position of the first image source 11 is well turned so that the main portion of the first image light P reflected by the windshield A″ can reach the field of viewing of the driver I after the first polarizing image hits the windshield. The first polarized image light P emitted by the first image source 11 goes to the light path combining component 12 firstly. The light path combining component 12 allows the first polarized image light P passing through and then arrives at the point A11, an inner surface A1 of the windshield A″. Thereafter, a part of the first polarized image light P is reflected by the windshield A: toward the eyes I′ of a driver. On the other hand, the second polarized image light S emitted by the second image source 13 directly goes off or is reflected at least one time off the point 1211 by the light path combining component 12. A primary part of the second polarized image light S is then reflected off by the light path combining component 12 to the point A11 of the inner surface A1 of the windshield A″. The second polarized image light S is partially reflected off by the windshield A″ to the eyes I of the driver.

Therefore, with the first polarized image light P and the second polarized image light S reflected by the inner surface A1 of the windshield A″ going to the eyes I of the driver, two virtual images 111, and 131 in front of the windshield A″ are simultaneously, in the viewing field of the driver. The distance between the first image source 11 and the light path combining component 12 is shorter than that of between the second image source 13 and the light path combining component 12. Thus, the length of the light path of second polarized image light S emitted from the second image source 13 to the eyes I of the drive is longer than that of the first polarized image lights P to the eyes I of the drive. As a result, the driver feels that the first virtual image 111 due to the first polarized image light P is nearer than a second virtual image 131 due to the second polarized image light S.

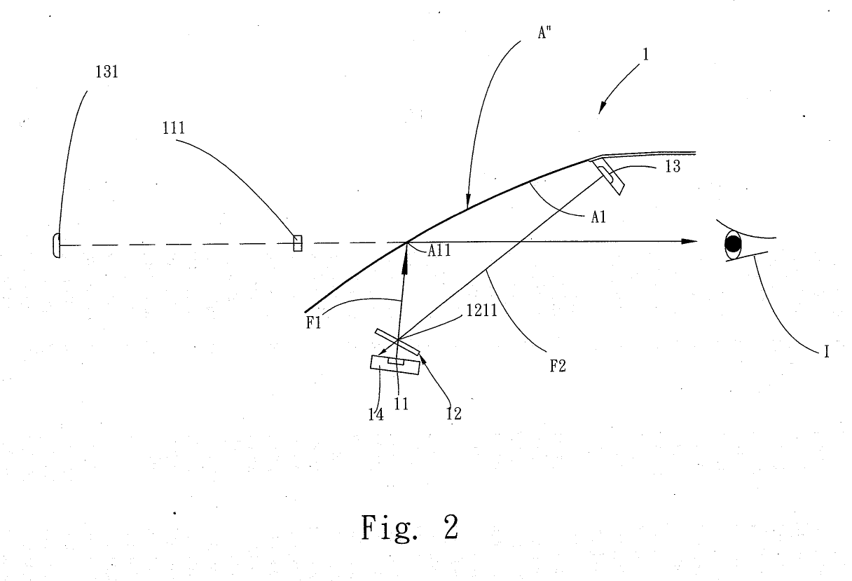

In a modified first preferred embodiment, the front surface of light path combining component 12 facing to the second image source 13′ has a curvature so as to magnify the second virtual image, as shown in FIG. 2A. In the other modified first preferred embodiment, the second image source is movable along the second optical axis, which is a direction in parallel with the line 16 to adjust magnification and position of the virtual image.

In according to a second embodiment of the present invention, the head-up display device 1 operated in a vehicle includes: a first image source 11 disposed under the windshield A″ and installed in the dashboard 14 of the vehicle; a second image source 13 mounted or hung at the ceiling of the vehicle. A light path combining component 12 in front of the first image source 11 has a transmitting mode and a mirror mode provided to be switched. Thus the light path combining component 12 may be called as a transparent/mirror switchable element.

In FIG. 2, it shows a schematic view of a first part of the second preferred embodiment, the light path combining component 12 is switched to the transmitting mode. The first image light F1 emitting by the first image source 11 goes through the light path combining component 12 and then reaches the point A111 of an inner surface A1 of the windshield A″. A part of the first image light F1 is then reflected by the windshield A″ to the eyes I of a driver and thus the driver may see a first virtual image 111 due to the first image source 11 in front of the windshield A″. On the other hand, none of the second image light F2 emitting by the second image source 13 can be reflected by the windshield A″ since the second image light directly passes through the light path combining component 12, which is transparent against the second image light F2 in a reversal direction leaving away the windshield A″.

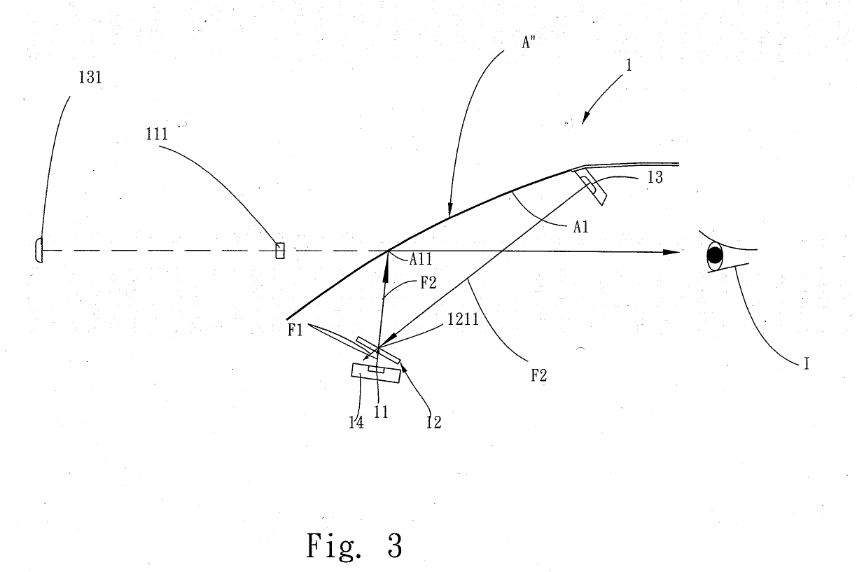

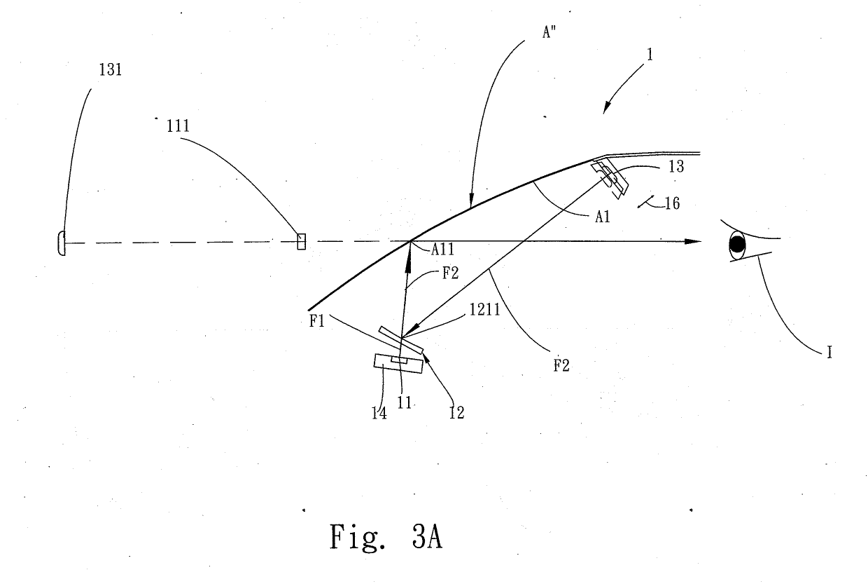

Referring to FIG. 3, it illustrates a schematic view of a second part of a second preferred embodiment of the head-up display device of the present invention. The light path combining component 12 is switched to a mirror mode. A part of the second image light F2 is reflected by the windshield A″ to the eyes I of a driver while the second image light F2 emitted by the second image source 13 goes to the mirror surface of the light path combining component 12 and then is reflected off and to the inner surface A1 of the windshield A″. On the other hand, none of the first image light F1 passes through the light path combining component 12 since the first image light F1 is reflected by the light path combining component 12. As a result, the driver can't see a first virtual image but a second virtual image 131 due to the second image source 13 instead in front of the windshield A″.

In a modified second preferred embodiment, the front surface of light path combining component 12 facing to the second image source 13′ has a curvature so as to magnify the second virtual image, as shown in FIG. 3A. In the other modified first preferred embodiment, the second image source is movable along the second optical axis, which is a direction in parallel with the line 16.

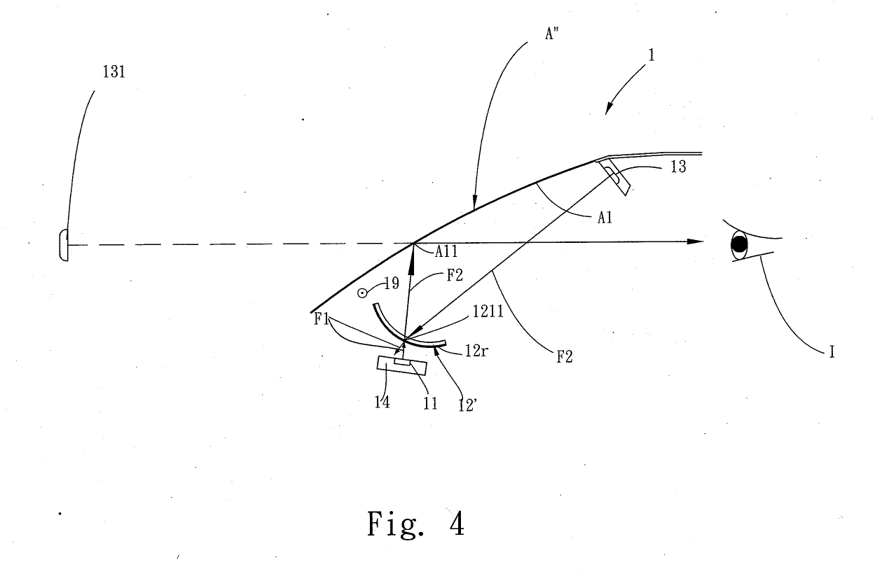

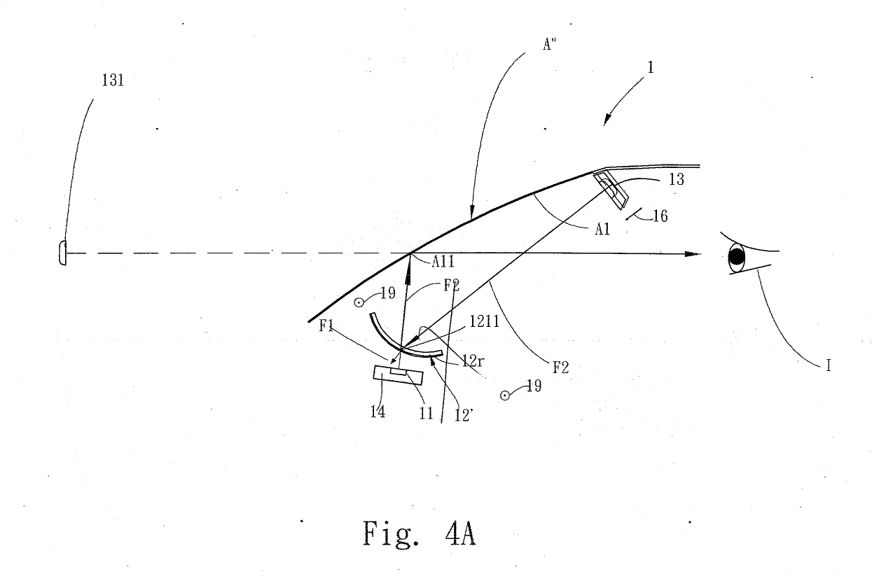

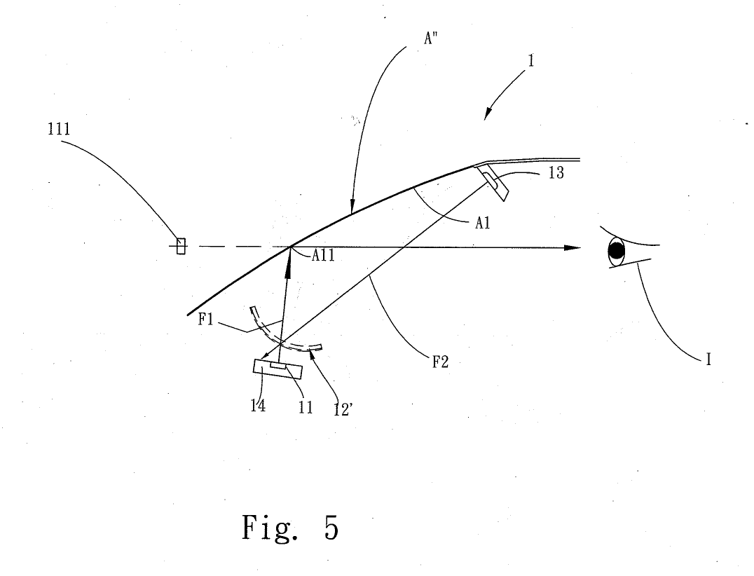

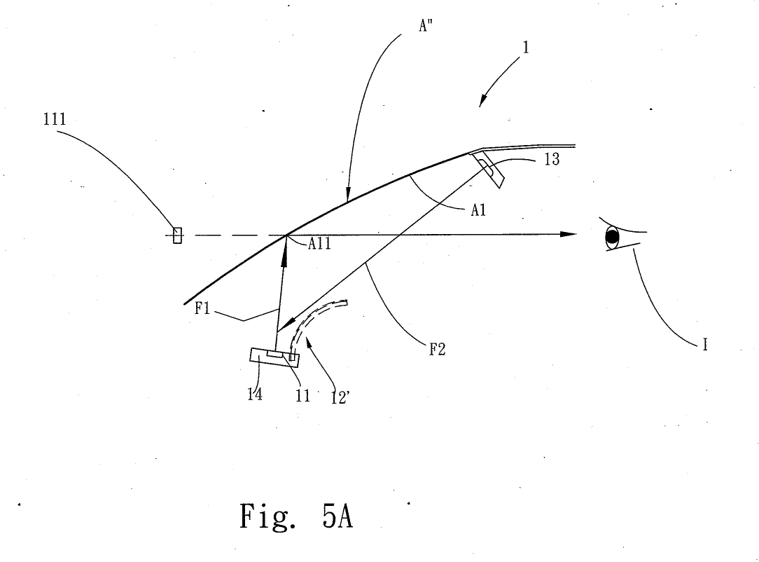

According to a third embodiment of the present invention, please refer to FIG. 4 and FIG. 5, the head-up display device 1 operated in a vehicle includes: a first image source 11, which is disposed under the windshield A″ and in the dashboard 14 of the vehicle, a mechanical movable shielding element 12′ in front of the first image source 11, and a second image source, which is mounted or hung at the ceiling of the vehicle abutting the windshield A″. In between the first image source 11 and the second image source 13, there is a mechanical movable shielding element 12′, which is nearer to the first image source than the second image source 13. In a preferred embodiment, facing to the second image source 13, the mechanical movable shielding element 12′ has a smooth front surface having an appropriate curvature, and has a reflected layer 12r, or multiple filtering layers 12r coated on the back surface thereof so that it 12′ can be used to magnify the second image source 13. The mechanical movable shielding element 12′ can be driven along the arrow direction 19 into the plane having the second optical axis of the second image source 13 and the first optical axis of the first image source 11 so as to block the first image light F1 out but reflect the second image light F2 instead, as shown in the FIG. 4 or be driven off the optical plane so that no second image light F2 can be reflected, as is shown in FIG. 5. The mechanical movable shielding element 12′ may be turned an predetermined angle around a pivot axis 125 so that the mechanical movable shielding element 12′ neither in the path of the first image light F1 nor in the path of the second image light F2 as is shown in FIG. 5A.

In FIG. 4, it shows the mechanical movable shielding element 12′ is driven into the optical axis plane, which has the first optical axis and second optical axis. As a result, the function of the mechanical movable shielding element 12′ is similar to and better than the light path combining component 12 being run in a mirror mode. Since the light path combining component 12 may not be run completely in a mirror mode. But the mechanical movable shielding element 12′ does. Furthermore, the second virtual image 131 can be magnified by the curvature of the mechanical movable shielding element 12′. e.g. a concave curvature, as shown in the FIG. 4.

In a modified embodiment of the third preferred embodiment, the second image source 13 is movable along the second optical axis, in parallel the direction 16, as shown in FIG. 4A. The movable second image source 13 may need a control module associated with a transmission module to cope with the moving of the second image source 13. In a preferred embodiment, the moving rate of the second image source 13 is dependent on the vehicle driven speed and instructed by the control module.

In FIG. 5, the mechanical movable shielding element 12′ shown by hidden lines to express the element 12′ is driven out of the optical axis plane. Thus, the first image light F1 emitting by the first image source 11 directly goes to the inner surface A1 of windshield A″ and then partially reflected by the windshield A″ toward the driven seat. The driver thus may see the first image 111 in front of the windshield A″. On the other hand, the second image light goes in a direction away from the windshield A″. No second image presents in the field of viewing of the driver

In the other embodiment, the mechanical movable shielding element 12′ is shifting associated with a little fine turning by a predetermined angle so as to save space demanded in comparison with simple turning around a fixed pivot axis. The mechanical movable shielding element 12′ is neither in the path of the first image light nor in the path of the second image light as shown in the FIG. 5A. The effects are the same as that of the FIG. 5.

The present invention are as follows:
1. In response to diversify driving situation, and for safely driving concerned, the head-up display device according to the present provided with two modes for long-distance and short-distance can be chosen. For instance, while driving at high speed, e.g., on the highway, a virtual image at distant may be preferred. By contrast, while driving at low speed, e.g., in the downtown, a virtual image at near may be preferred.
2. The head-up display device include two image sources, the first image source in the dashboard and the second image source hung at the ceiling of the vehicle. The first image source provides the virtual image at a closer distance from the driver without magnification, and the second image source provides the virtual image at a longer distance from the driver with or without magnification. Due to the short distance of the light path from the first image source to the windshield, the device can provide large size of closer distance virtual image without light path occupying large space in the vehicle.
3. Using two image sources also prevent the virtual image size for closer and longer distance from coupling or interfering with each other. In addition, the switching between closer and longer distance virtual image can be made without mechanical movement, or only simple shielding/non-shielding mechanical movement, by using two image source configuration. Sophisticated or precision mechanical movement is not preferred in the vehicles where there are often involved with high speed motion and various vibration modes.

Although the invention has been disclosed and illustrated with reference to particular embodiments, the principles involved are susceptible for use in numerous other embodiments that will be apparent to persons skilled in the art. This invention is, therefore, to be limited only as indicated by the scope of the appended claims

What is claimed is:

1. A head-up display device that is operated in a vehicle comprising:
a first image source, which is disposed under a windshield and in a dashboard of the vehicle, the first image source emitting a first polarized image light;
a polarizing beam splitter, which is disposed in front of and spaced from the first image source by a first distance, such that the first polarized image light emitted by the first image source having primary a first polarization component thereof going through the polarizing beam splitter to the windshield and then partially reflected the first polarization component to eyes of a driver by the windshield;
a second image source, attached on a ceiling abutting a top of the windshield, and spaced from the polarizing beam splitter by a second distance, the second image source emitting a second polarized image light, having primary a second polarization component hitting the polarizing beam splitter then reflected to the windshield, and then partially reflected to the eyes of the driver, wherein the first distance is shorter than the second distance and the first polarized image light and the second polarized image light in a significantly opposite direction toward the polarizing beam splitter;
wherein the driver can thus through the windshield see a near distance virtual image due to the first image source and a far distance virtual image due to the second image source.

2. The head-up display device according to claim 1, wherein both of the first polarization component of the first polarization image light and the second polarization component of the second polarization image light are mutual orthogonal linear type polarization and the polarizing beam splitter is a liner type polarization beam splitter.

3. The head-up display device according to claim 1, wherein both of the first polarization component of the first polarization image light and the second polarization component of the second polarization image light are mutual opposite hands circular polarization and the polarizing beam splitter is a circular polarizing type beam splitter.

4. The head-up display device according to claim 1 wherein an angle of the polarizing beam splitter is tuned with respect to the second image source so that the main reflected portion of the second image light will reach the eyes of the driver.

5. The head-up display device according to claim 1 wherein an angle of the first image source is tuned so that the main reflected portion of the first image light will reach the eyes of the driver while the first image light hits the windshield after passing through the polarizing beam splitter, and further reflected by the windshield.

6. The head-up display device according to claim 1 wherein the polarizing beam splitter has a curvature to magnify the second image source.

7. The head-up display device according to claim 1 wherein the second image source is movable along the second optical axis.

8. A head-up display device that is operated in a vehicle comprising:
a first image source, which is disposed under a windshield and in a dashboard for emitting a first image light;
a second image source, attached on a ceiling and abutting a top of the windshield;
a transparent/mirror switchable element having a transmitting mode and a mirror mode to be switched, which is disposed in between the first image source and the second image source, and spaced from the first image source by a first distance, and spaced from the second image source by a second distance,
wherein when the transparent/mirror switchable element is operated in a mirror mode, the transparent/mirror switchable element reflects primary the second image light to and off the windshield by reflecting to eyes of a driver, but reflects the first image light away from the windshield so that a second virtual image due to the second image light could be seen by the driver seating at a driven seat but a first virtual image due to the first image light is absent;
wherein when the transparent/mirror switchable element is operated in a transparent mode, the transparent/mirror switchable element allows primary the first image light passing through to and off the windshield by reflecting to the eyes of the driver so that the first virtual image due to the first image light could be seen by the driver seating at the driven seat.

9. The head-up display device according to claim 8, wherein the first distance and the second distance are always different so that the position of the first virtual image is always different from that of the second virtual image.

10. The head-up display device according to claim 8 wherein an angle of the transparent/mirror switchable element is tuned with respect to the second image source so that the main reflected portion of the second image light will reach the eyes of the driver after the reflected second image light hits the windshield and is further reflected by the windshield.

11. The head-up display device according to claim 8 wherein the transparent/mirror switchable element has a curvature to magnify the second image source.

12. The head-up display device according to claim 8 wherein the second image source is movable along the second optical axis.

13. A head-up display device that is operated in a vehicle comprising:
a first image source, which is disposed under a windshield and in a dashboard for emitting a first image light and with a first optical axis toward the windshield in a way that when the first image light reaches the windshield, the main portion of the reflected first image light by the windshield will reach a driver seat;
a second image source, attached on a ceiling and abutting a top of the windshield;
a mechanical movable shielding element being movable or turned around a movable axis so that the mechanical movable shielding element is disposed in a path of the first image light and a path of the second image light to block out the first image light but reflect main portion of the second image light to hit the windshield and then is further reflected by the windshield and the main reflected portion of the second image light will reach the driver seat so as to choose a second virtual image due to the second image light being seen by the driver or is disposed out of the paths so as to choose a first virtual image due to the first image light being seen by the driver.

14. The head-up display device according to claim 13 wherein the mechanical movable shielding element has a curvature mirror surface facing to the second image source to magnify the second image source.

15. The head-up display device according to claim 13 wherein the second image source is movable along the second optical axis.

16. The head-up display device according to claim 15 wherein the quantity of displacement of the second image source along the second optical axis is dependent on the vehicle speed.

17. The head-up display device according to claim 13 wherein an angle of the mechanical movable shielding element is tuned with respect to the second image source so that the main reflected portion of the second image light will reach the eyes of the driver after the reflected second image light hits the windshield and is further reflected by the windshield.
